(19) United States
(12) Patent Application Publication
(10) Pub. No.: US 2009/0160791 A1
(43) Pub. Date: Jun. 25, 2009

(54) Non-contact touch screen

(75) Inventor: Klony Lieberman, Jerusalem (IL)

Correspondence Address: KLONY LIEBERMAN;LUMIO INC., 5 NAHUM HEFZADI ST., JERUSALEM, 95484, IL

(73) Assignee: LUMIO, Menlo Park, CA (US)

(21) Appl. No.: 12/176,430

(22) Filed: Jul. 21, 2008

Related U.S. Application Data
(60) Provisional application No. 61/014,763, filed on Dec. 19, 2007.

(51) Int. Cl. G06F 3/041

(52) U.S. Cl. 345/173

(57) ABSTRACT

A non-contact actuable touch screen including a display screen adapted to display on a generally planar display surface thereof a plurality of mutually spaced target regions, any two adjacent ones of the mutually spaced target regions being mutually separated along the planar display surface by at least a lateral separation distance and an actuation assembly defining an actuation plane generally parallel to and spaced forward of the planar display surface of the display screen and being operative to sense presence of a user touch indicator at the actuation plane and to provide an output indication of two-dimensional spatial coordinates of the presence.

### REFERENCE TO RELATED APPLICATIONS

Reference is hereby made to U.S. Provisional Patent Application 61/014,763 entitled REMOTE ACTIVATION TOUCH SCREEN, filed Dec. 19, 2007, the disclosure of which is hereby incorporated by reference and priority of which is hereby claimed pursuant to 37 CFR 1.78(a) (4) and (5)(i).

### FIELD OF THE INVENTION

The present invention relates to touch screens generally.

### BACKGROUND OF THE INVENTION

The following U.S. patent publications are believed to represent the current state of the art: U.S. Pat. Nos. 6,377,238; 6,008,800 and 5,900,863.

### SUMMARY OF THE INVENTION

The present invention seeks to provide an improved touch screen and method of operating same.

There is thus provided in accordance with a preferred embodiment of the present invention a non-contact actuable touch screen including a display screen adapted to display on a generally planar display surface thereof a plurality of mutually spaced target regions, any two adjacent ones of the mutually spaced target regions being mutually separated along the planar display surface by at least a lateral separation distance and an actuation assembly defining an actuation plane generally parallel to and spaced forward of the planar display surface of the display screen and being operative to sense presence of a user touch indicator at the actuation plane and to provide an output indication of two-dimensional spatial coordinates of the presence.

Preferably, the actuation plane is spaced from the planar display surface of the display screen by a perpendicular separation distance extending perpendicular to the actuation plane which is less than the lateral separation distance. Additionally or alternatively, the actuation assembly is operative to generate a light curtain in the actuation plane.

In accordance with a preferred embodiment of the present invention the actuation assembly is displaced forward of and separated from the planar display surface.

Preferably, for a non perpendicular viewing angle, a perceived actuation target region, which corresponds to a first display target region on the display screen, at least partially overlies an actuation target region corresponding to the first display target region. Additionally or alternatively, for a viewing angle of at most 45 degrees from the perpendicular, a perceived actuation target region, which corresponds to a first display target region does not at least partially overlie an actuation target region corresponding to a second display target region adjacent to the first display target region.

In accordance with a preferred embodiment of the present invention the display screen and the actuation assembly are each formed as a separate unit and are individually replaceable. Alternatively, the display screen and the actuation assembly are integrally formed.

There is also provided in accordance with another preferred embodiment of the present invention a method of operating a non-contact actuable touch screen including a generally planar display screen and an actuation assembly defining an actuation plane generally parallel to and spaced from the display screen, the method including displaying on a planar display surface of the display screen, a plurality of mutually spaced target regions, placing a user touch indicator in the actuation plane in non-contact relationship with the planar display surface of the display screen and employing the actuation assembly to sense presence of the user touch indicator at the actuation plane and to provide an output indication of two-dimensional spatial coordinates of the presence.

Preferably, the method also includes generating a light curtain in the actuation plane and employing the light curtain to sense the presence of the user touch indicator at the actuation plane. Additionally or alternatively, the actuation plane is spaced from the planar surface of the display screen by a distance extending perpendicular to the actuation plane which is less than the minimum separation along the planar surface between at least two adjacent ones of the mutually spaced target regions.

In accordance with a preferred embodiment of the present invention the actuation assembly is displaced forward of and separated from the planar display surface by a perpendicular actuation assembly separation distance.

### BRIEF DESCRIPTION OF THE DRAWINGS

The present invention will be understood and appreciated more fully from the following detailed description, taken in conjunction with the drawings in which:

FIGS. 1 and 2 are simplified respective pictorial and side view illustrations of a non-contact actuable touch screen constructed and operative in accordance with a preferred embodiment of the present invention;

FIG. 3 is a simplified pictorial illustration illustrating typical operation of the non-contact actuable touch screen of FIGS. 1 & 2; and

FIGS. 4A and 4B illustrate preferred spatial relationships between a minimum separation distance between target regions on a display screen and a perpendicular separation distance between a display screen and an actuation plane.

### DETAILED DESCRIPTION OF A PREFERRED EMBODIMENT

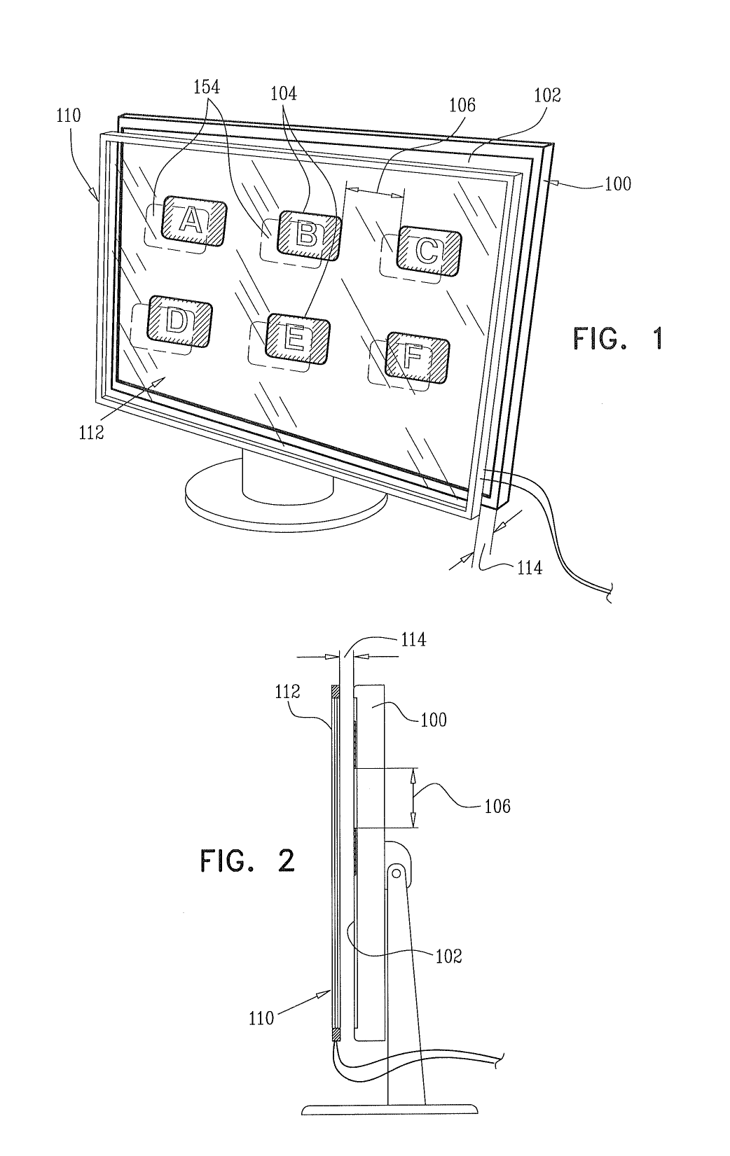

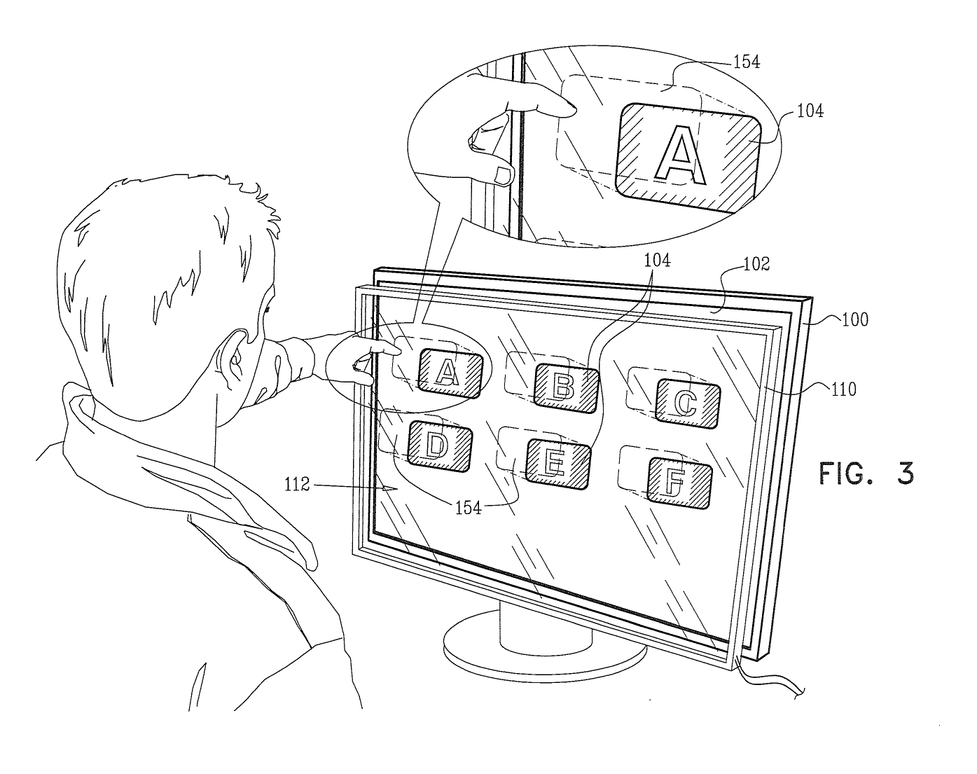

Reference is now made to FIGS. 1 and 2, which are simplified respective pictorial and side view illustrations of a non-contact actuable touch screen constructed and operative in accordance with a preferred embodiment of the present invention.

As seen in FIGS. 1 and 2, the non-contact actuable touch screen of the present invention may comprise a conventional display screen 100, such as a conventional flat screen. Alternatively, display screen may be a conventional CRT screen, a forward or rearward projection screen, a fixed printed image or any other suitable visually sensible display.

In accordance with a preferred embodiment of the present invention, display screen 100 displays, or is adapted to display, on a generally planar display surface 102 thereof, a plurality of mutually spaced target regions 104. Preferably, any two adjacent ones of said mutually spaced target regions 104, such as regions A and B, are mutually separated along the planar display surface by at least a minimum lateral separation distance, here indicated by reference numeral 106. In the illustrated embodiment, distance 106 is the minimum separation along the generally planar display surface 102 between adjacent mutually spaced target regions 104.

In accordance with a preferred embodiment of the present invention, an actuation assembly 110 is provided, defining an actuation plane 112 generally parallel to and spaced forward of the planar display surface 102 of the display screen 100. Actuation assembly 110 is preferably displaced forwardly of and separated from generally planar display surface 102 by a perpendicular actuation assembly separation distance 114. Actuation assembly 110 is operative to sense the presence of a user touch indicator (not shown), such as a user's finger or a stylus, at actuation plane 112 and to provide an output indication of two-dimensional spatial coordinates of the sensed presence, such as a signal indicating X and Y coordinates of the user touch indicator.

Actuation assembly 110 is preferably operative to generate a light curtain in actuation plane 112 and to sense impingement on the light curtain by a user touch indicator, such as a finger or stylus. Actuation assembly 110 is preferably an optical touch sensing frame, such as the optical touch screen described in applicant/assignee's U.S. Pat. Nos. 7,302,156, 7,333,094 and 7,333,095, the disclosures of which are hereby incorporated by reference. Alternatively, actuation assembly 110 may be an optical sensing element, such as the error proofing apparatus described in applicant/assignee's U.S. Pat. No. 7,268,692, the disclosure of which is hereby incorporated by reference.

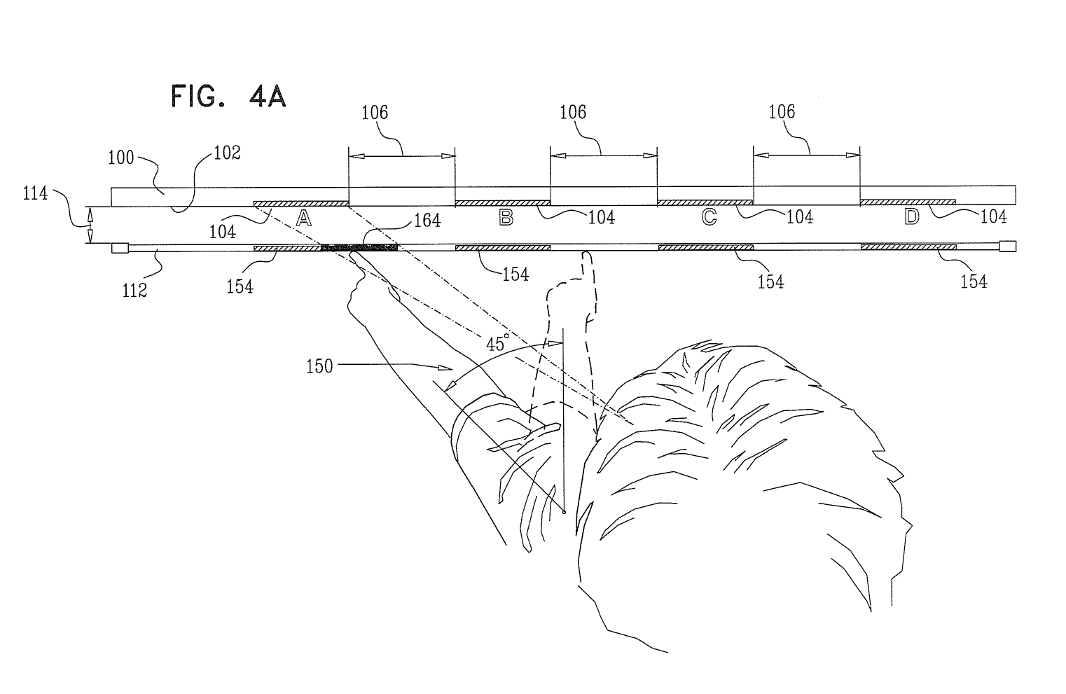

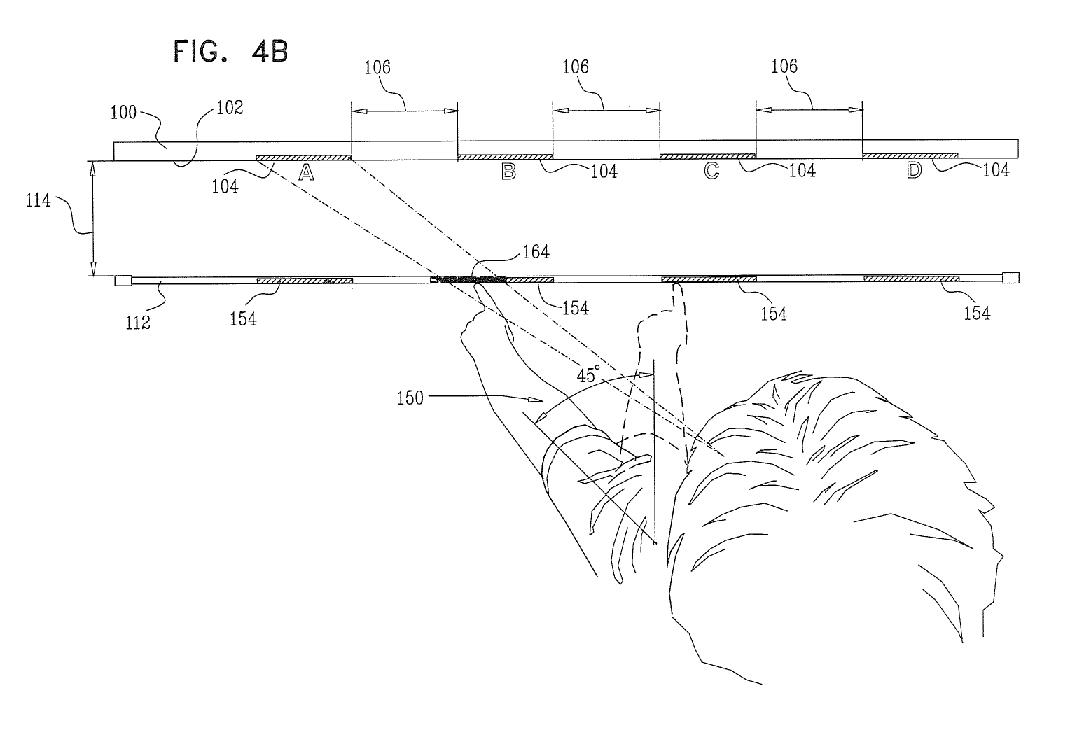

Reference is now made to FIG. 3, which is a simplified pictorial illustration illustrating typical operation of the non-contact actuable touch screen of FIGS. 1 & 2, and to FIGS. 4A and 4B, which illustrate preferred spatial relationships of minimum separation distance 106 between target regions 104 on a display screen 102 and a perpendicular separation distance 114 between a generally planar display surface of display screen 102 and actuation plane 112. FIGS. 4A and 4B are drawn for an outer limit case of viewing the touch screen at a 45 degree angle, indicated by reference numeral 150.

It is a particular feature of the present invention that actuation target regions 154 are defined in the actuation plane 112, overlying corresponding display target regions 104, and are perpendicularly offset therefrom by perpendicular separation distance 114 but are not laterally offset with respect to corresponding display target regions 104.

FIG. 4A shows a preferred arrangement wherein the lateral separation distance 106 between adjacent target regions 104, such as target regions A and B, is greater than the perpendicular separation distance 114. In this case, it is seen that a user's perception of the location of a user indicator is that the location of the user indicator is within a perceived actuation target region, here designated by reference numeral 164, which corresponds to display target region A and which at least partially overlies the actuation target region 154 corresponding to the same display target region A.

FIG. 4B shows a non-preferred arrangement wherein the lateral separation distance 106 between adjacent target regions 104, such as target regions A and B, is less than the perpendicular separation distance 114. In this case, it is seen that a user's perception of the location of a user indicator is that the location of the user indicator is within a perceived actuation target region 164, which corresponds to display target region A and which at least partially overlies the actuation target region 154 corresponding to a different display target region, here target region B.

In a preferred embodiment of the present invention, display screen 100 and acutation assembly 110 are each formed as a separate unit. In this embodiment, display screen 100 and actuation assembly 110 may be individually replaceable, such as in the event of upgrade or malfunction, such that the user need not replace both display screen 100 and actuation assembly 110. Alternatively, display screen 100 and actuation assembly 110 may be integrally formed.

It will be appreciated by persons skilled in the art that the present invention is not limited by what has been particularly shown and described hereinabove but rather the scope of the present invention includes both combinations and sub-nations combinations of the various features of the present invention as well as modifications and variations thereof which would occur to persons skilled in the art upon reading the foregoing description and which are not in the prior art.

1. A non-contact actuable touch screen comprising:
a display screen adapted to display on a generally planar display surface thereof a plurality of mutually spaced target regions, any two adjacent ones of said mutually spaced target regions being mutually separated along said planar display surface by at least a lateral separation distance; and
an actuation assembly defining an actuation plane generally parallel to and spaced forward of said planar display surface of said display screen and being operative to sense presence of a user touch indicator at said actuation plane and to provide an output indication of two-dimensional spatial coordinates of said presence.

2. A non-contact actuable touch screen according to claim 1 and wherein said actuation plane is spaced from said planar display surface of said display screen by a perpendicular separation distance extending perpendicular to said actuation plane which is less than said lateral separation distance.

3. A non-contact actuable touch screen according to claim 2 and wherein said actuation assembly is operative to generate a light curtain in said actuation plane.

4. A non-contact actuable touch screen according to claim 1 and wherein said actuation assembly is operative to generate a light curtain in said actuation plane.

5. A non-contact actuable touch screen according to claim 1 and wherein said actuation assembly is displaced forward of and separated from said planar display surface.

6. A non-contact actuable touch screen according to claim 1 and wherein, for a non perpendicular viewing angle, a perceived actuation target region, which corresponds to a first display target region on said display screen, at least partially overlies an actuation target region corresponding to said first display target region.

7. A non-contact actuable touch screen according to claim 1 and wherein, for a viewing angle of at most 45 degrees from the perpendicular, a perceived actuation target region, which corresponds to a first display target region does not at least partially overlie an actuation target region corresponding to a second display target region adjacent to said first display target region.

8. A non-contact actuable touch screen according to claim 1 and wherein said display screen and said actuation assembly are each formed as a separate unit and are individually replaceable.

9. A non-contact actuable touch screen according to claim 1 and wherein said display screen and said actuation assembly are integrally formed.

10. A method of operating a non-contact actuable touch screen including a generally planar display screen and an actuation assembly defining an actuation plane generally parallel to and spaced from said display screen, the method comprising
displaying on a planar display surface of said display screen, a plurality of mutually spaced target regions;
placing a user touch indicator in said actuation plane in non-contact relationship with said planar display surface of said display screen; and
employing said actuation assembly to sense presence of said user touch indicator at said actuation plane and to provide an output indication of two-dimensional spatial coordinates of said presence.

11. A method of operating a non-contact actuable touch screen according to claim 10 and also comprising generating a light curtain in said actuation plane and employing said light curtain to sense said presence of said user touch indicator at said actuation plane.

12. A method of operating a non-contact actuable touch screen according to claim 10 and wherein said actuation plane is spaced from said planar surface of said display screen by a distance extending perpendicular to said actuation plane which is less than the minimum separation along said planar surface between at least two adjacent ones of said mutually spaced target regions.

13. A method of operating a non-contact actuable touch screen according to claim 10 and wherein said actuation assembly is displaced forward of and separated from said planar display surface by a perpendicular actuation assembly separation distance.

14. A method of operating a non-contact actuable touch screen according to claim 11 and wherein said actuation assembly is displaced forward of and separated from said planar display surface by a perpendicular actuation assembly separation distance.

15. A method of operating a non-contact actuable touch screen according to claim 12 and wherein said actuation assembly is displaced forward of and separated from said planar display surface by a perpendicular actuation assembly separation distance.
